(19) United States
(12) Patent Application Publication
(10) Pub. No.: US 2018/0319492 A1
(43) Pub. Date: Nov. 8, 2018

(54) ROTOR BLADE STRUCTURES

(71) Applicant: Sikorsky Aircraft Corporation, Stratford, CT (US)

(72) Inventors: Justin Thomas, New Haven, CT (US); Krzysztof Kopanski, Trumbull, CT (US); Mark W. Scott, Bethany, CT (US)

(21) Appl. No.: 15/772,453

(22) PCT Filed: Oct. 25, 2016
(86) PCT No.: PCT/US16/58564

§ 371 Date: Apr. 30, 2018

Related U.S. Application Data
(60) Provisional application No. 62/252,741, filed on Nov. 9, 2015.

(51) Int. Cl. B64C 27/72; B64C 27/64; B64C 27/473

(52) U.S. Cl. CPC B64C 27/72; B64C 2027/7272; B64C 27/473; B64C 27/64

(57) ABSTRACT

A closeout structure for a rotor blade includes a first fluid channel for supplying a first pressure to a first port of a trailing edge (TE) device, a second fluid channel for supplying a second pressure to a second port of the TE de vice, and a trough disposed between the first fluid channel and the second fluid channel. The closeout structure forms a double-W shape.

### CROSS REFERENCE TO RELATED APPLICATIONS

The subject invention claims the benefit of and priority to U.S. Provisional Application Ser. No. 62/252,741 filed Nov. 9, 2015, the disclosure of which is herein incorporated by reference in its entirety.

### STATEMENT OF GOVERNMENT RIGHTS

This invention was made with government support under contract no. No. FA8650-13-C-7304 awarded by DARPA. The government has certain rights in the invention.

### BACKGROUND

### 1. Field

The present disclosure relates to rotor blade assemblies, more specifically to rotor blade assemblies having trailing edge devices (e.g., flaps) or other actuated mechanisms.

### 2. Description of Related Art

For a rotor blade, trailing edge (TE) devices can be used that move relative to the blade. Certain TE devices include pneumatically driven valves. The inclusion of TE devices and the supporting pneumatic conduits in traditional blades add complexity to manufacture and maintenance.

Such conventional methods and systems have generally been considered satisfactory for their intended purpose. However, there is still a need in the art for improved rotor blade structures. The present disclosure provides a solution for this need.

### SUMMARY

A closeout structure for a rotor blade includes a first fluid channel having a first port which supplies a first pressure to the TE device via the first port, a second fluid channel having a second port which supplies a second pressure to the TE device via the second port, and a trough which forms a seal between the first channel. The closeout structure forms a double-W shape.

The structure can be defined by a first W-shaped member and a second W-shaped member nested at least partially within the first W-shape member to form the double W-shape. In certain embodiments, the second W-shaped member can have a shallower second member trough than a first member trough of the first W-shaped member such that the first member trough bottoms out on the second member trough, sealing the first and second fluid channels.

The first and second W-shaped members can be adhered together. The first W-shaped member can include at least one hole in the first and second fluid channels for ports to fluidly communicate the first and second fluid channels and the ports.

The closeout structure can have a length as long as a blade interior of the rotor blade. In certain embodiments, the first channel can be sealed at a tip end and the second fluid channel can be sealed at a root end.

A rotor blade can include a trailing edge (TE) device disposed within the rotor blade and configured to operate with a differential pressure, the TE device including a first port and a second port. The rotor blade can include a cavity extending at least a portion of the length of the rotor blade. The rotor blade can further include a closeout structure as described above disposed in the cavity. The rotor blade can include a valve which selectively opens and closes the first and/or second ports to selectively activate the TE device.

A rotorcraft can include a plurality of rotor blades as described above. The rotorcraft can further include a controller which controls the TE by selectively applying differential pressure via the first fluid channel and the second fluid channel. The rotorcraft can include a valve which selectively opens and closes the first and/or second ports to selectively activate the TE device.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1A is a plan view of an embodiment of a rotor blade in accordance with this disclosure;

FIG. 1B is a cross-sectional end view of the blade of FIG. 1A showing a closeout structure disposed within a blade cavity;

FIG. 1C is a cross-sectional elevational view of a portion of the closeout structure of FIG. 1B;

FIG. 1D is a plan view of a root portion of the blade of FIG. 1A, showing a root pressure opening;

FIG. 1E is a plan view of a tip portion of the blade of FIG. 1A, showing a tip pressure opening;

FIG. 2A is a partial cross-sectional view of an embodiment of trailing edge device shown operatively connected to an embodiment of a closeout structure;

FIG. 2B is a partial cross-sectional view of another embodiment of a closeout structure associated with a trailing edge device, shown having forward nut plates and core material; and

FIG. 3 is a side elevation view of an embodiment of a rotorcraft in accordance with this disclosure.

### DETAILED DESCRIPTION

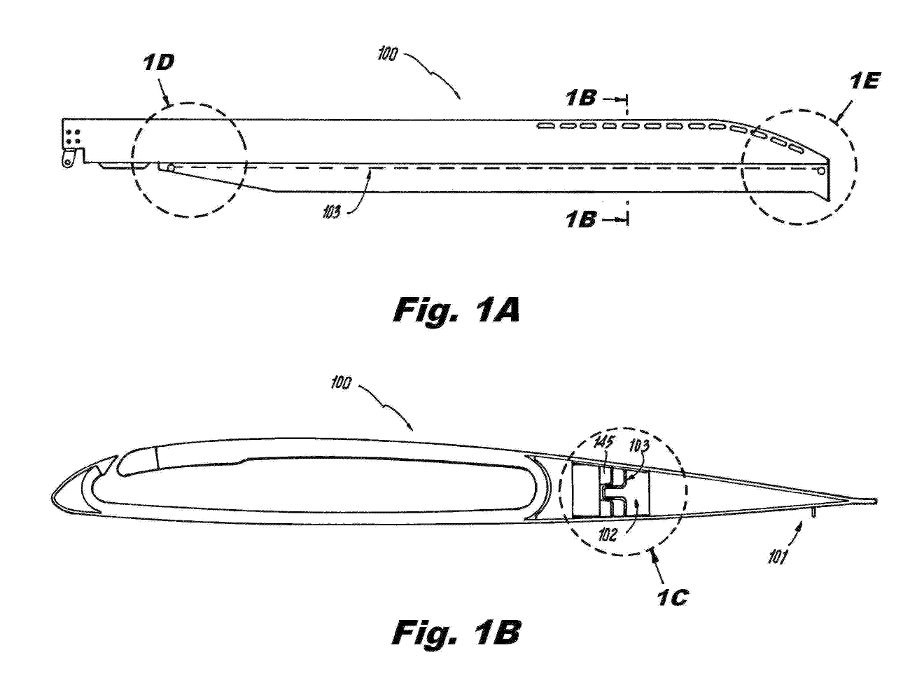

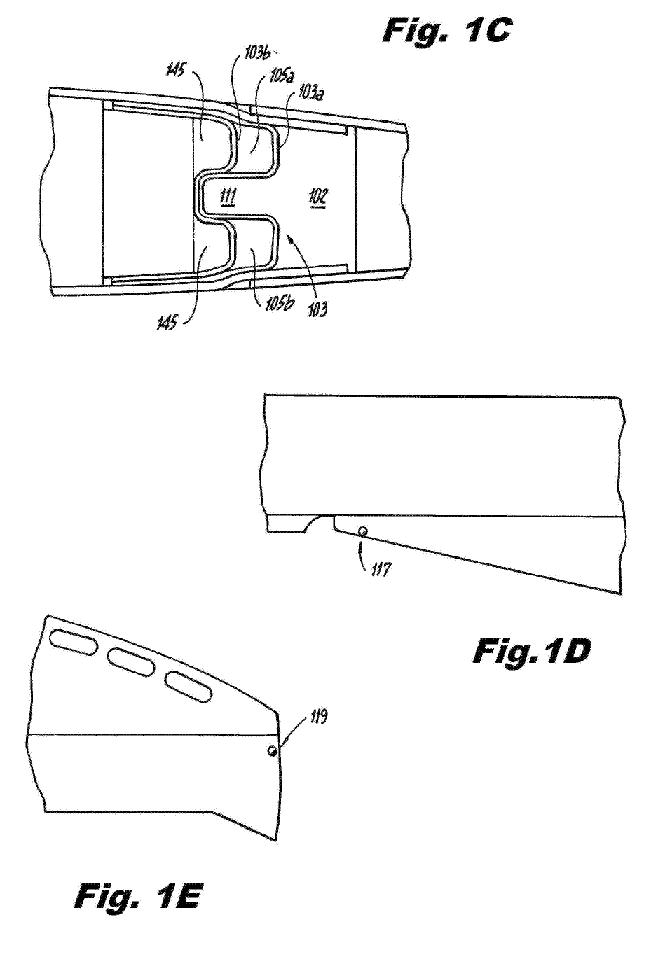

Reference will now be made to the drawings wherein like reference numerals identify similar structural features or aspects of the subject disclosure. For purposes of explanation and illustration, and not limitation, an illustrative view of an embodiment of a blade in accordance with the disclosure is shown in FIG. 1A and is designated generally by reference character 100. Other embodiments and/or aspects of this disclosure are shown in FIGS. 1B-3. The systems and methods described herein can be used to provide a differential pressure to a trailing edge (TE) device.

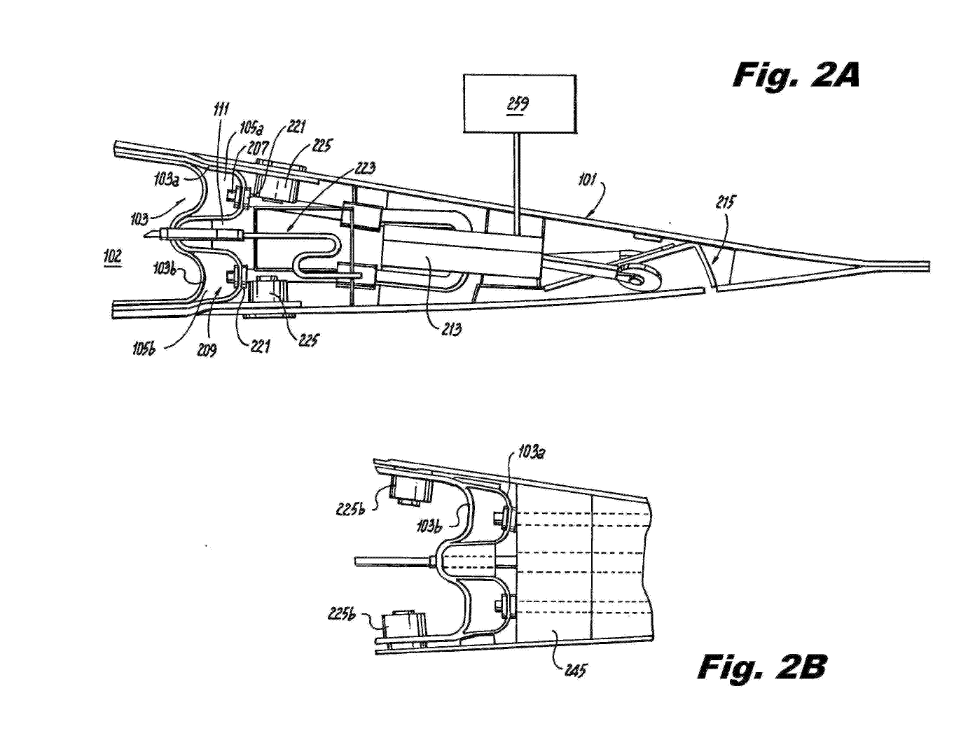

Referring to FIG. 1A-1E, a rotor blade 100 can include a trailing edge (TE) device 101 disposed within the rotor blade 100. The TE device 101 can be configured to operate with a differential pressure. The rotor blade 100 can define a cavity 102 (e.g., in an aft portion of blade 100 forward of the TE device 101). In certain embodiments, the cavity 102 can be at least partially filled with core material 145 (also see core material 245 in FIG. 2B), which can include any suitable material (e.g., foam).

As shown in FIGS. 1B and 1C, a closeout structure 103 for a rotor blade 100 can include a first fluid channel 105a and a second fluid channel 105b. The closeout structure 103 can be configured to fit within at least a portion of the cavity 102. As shown, a trough 111 is disposed between the first fluid channel 105a and the second fluid channel 105b such that the closeout stricture 103 forms a double-W shape. As shown, the core material 145 can be shaped to

Referring to FIG. 2A, the first fluid channel 105a is configured to supply a first pressure fluid to a first port 207 of the TE device 101. The second fluid channel 105b is configured to supply a second pressure fluid to a second port 209 of the TE device 101, with a pressure differential between the first and second pressures powering the TE device 101. In certain embodiments, the first fluid channel 105a can convey a higher pressure to the first port 207 than that conveyed to the second port 209 by the second fluid channel 105b, and the fluid can be air.

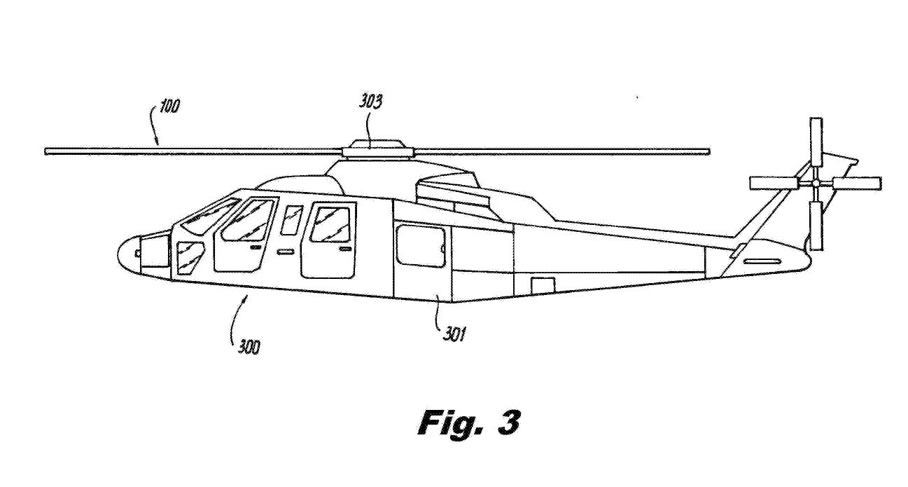

For example, referring additionally to FIG. 1D, the first fluid channel 105a can be in fluid communication with a root pressure opening 117 at a root portion of the blade 100 which has a relatively high pressure during operation. Referring additionally to FIG. 1E, the second fluid channel 105b can be in fluid communication with a tip pressure opening 119 at the tip of the blade 100 which has a relatively low pressure during operation. In this manner, the first channel can be sealed at a tip end of the blade 100 and the second fluid channel can be sealed at a root end of the blade 100. A differential pressure valve 213 of the TE device 101 can actuate a TE device effector (e.g., flap 215) when a suitable differential pressure acts on the valve 213 between the ports 207, 209 (e.g., due to a differential pressure between the root and the tip of the blade 100 when rotating). Electrical components 223 can be operatively connected to the TE device 101 to selectively control the valve 213 (e.g., via a suitable controller 259 disposed on the blade 100, on the rotor hub 303 as shown in FIG. 3, and/or in the fuselage 301 as shown in FIG. 3 such as in a flight control computer) to actuate in response to a differential pressure.

As shown in FIGS. 1B, 1C, and 2A, the closeout structure 103 can be defined by a first W-shaped member 103a and a second W-shaped member 103b. The second W-shaped member 103b can be nested at least partially within the first W-shape member 103a to form the double W-shape. As shown, the second W-shaped member 103b can have a shallower second member trough than a first member trough of the first W-shaped member 103a such that the first and. second fluid channels 105a, 105b are formed between the first W-shaped member 103a and the second W-shaped member 103b. The first member trough can bottom out on the second member trough, thereby sealing the first and second fluid channels 105a, 105b.

Each W-shaped member 103a, 103b can be made of composite material (e.g., carbon fiber) and/or include any other suitable material (e.g., aluminum sheet metal). The first and second W-shaped members 103a, 103b can be adhered/bonded together at any suitable portion thereof (e.g., along the side walls, along the trough, and/or any other location), or assembled in any other suitable manner. Any other suitable arrangement to form the double W-shape is contemplated herein. For example, the closeout structure 103 can be made as a single piece (e.g., via casting or additive manufacturing), or out of any other suitable number of components.

The closeout structure 103 can be connected to the inside of the blade 100 in any suitable manner (e.g., via adhesive, via TE device nut plates As shown in FIG. 2A, the nut plates 225 can be positioned aft of the closeout structure 103. However, as shown in FIG. 2B, the nut plates 225a can be moved forward (toward leading edge of blade 100) forward of fluid channels 105a, 105b. Placing the nut plates 225a forward can assist in resisting negative impact of local bending forces. It is contemplated that the blade 100 can be formed integrally with the closeout structure 103.

The first W-shaped member 103a can include at least one hole in the first and second fluid channels 105a, 105b for ports 207, 209 to fluidly communicate the first fluid channel 105a and the port 207, and second fluid channel 105b and the port 209. A suitable seal 221 can be disposed within the holes and around each port 207, 209 to seal the channels 105a, 105b from the cavity 102. The closeout structure 103 can have a length as long as a blade interior (e.g., the cavity 102) of the rotor blade 100.

Referring to FIG. 3, a rotorcraft 300 can include a plurality of rotor blades 100 as described above attached to a rotor hub 303 which is rotatable connected to a fuselage 301. The rotor blades 100 can include a TE device and closeout structure 103 as described above. While the rotorcraft 300 is shown as a single rotor helicopter, any suitable rotorcraft can employ one or more blades 100 as described above. By way of example, aspects of the invention can be used in coaxial helicopters, on tail rotors, or wings or propeller blades on fixed or tilt wing aircraft.

As described above, the two channels 105a, 105b provide the valve of the TE device 101 with access to high and low pressure air. Referring to FIG. 2, the trough 111 provides space for the electrical components 223 (e.g., wires and connectors). Traditional designs do not support integration of a TE device 101 including conduits for wires and sources for pressure. The double-W geometry of the closeout structure 103 as described above is a low weight and effective solution to this problem.

The methods and systems of the present disclosure, as described above and shown in the drawings, provide for blades and components thereof with superior properties including structures for supporting trailing end devices. While the apparatus and methods of the subject disclosure have been shown and described with reference to embodiments, those skilled in the art will readily appreciate that certain changes and/or modifications may be made thereto without departing from the spirit and scope of the subject disclosure.

1. A closeout structure for a rotor blade having a trailing edge (TE) device, comprising:
a first fluid channel having a first port which supplies a first pressure to the TE device via the first port;
a second fluid channel having a second port which supplies a second pressure to the TE device via the second port; and
a trough which forms a seal between the first channel and the second fluid channel, wherein the closeout structure forms a double-W shape.

2. The structure of claim 1, wherein the structure is defined by a first W-shaped member and a second W-shaped member nested at least partially within the first W-shape member to form the double W-shape, wherein the second W-shaped member has a shallower second member trough than a first member trough of the first W-shaped member such that the first member trough bottoms out on the second member trough, sealing the first and second fluid channels.

3. The structure of claim 1, wherein the first and second W-shaped members are adhered together.

4. The structure of claim 1, wherein the first W-shaped member includes at least one hole in the first and second fluid channels for ports to fluidly communicate the first and second fluid channels and the ports.

5. The structure of claim 1, wherein the structure has a length as long as a blade interior of the rotor blade.

6. The structure of claim 1, wherein the first channel is sealed at a tip end of the rotor blade and open at a root end of the rotor blade and the second fluid channel is sealed at the root end of the rotor blade and open at the tip end of the rotor blade.

7. A rotor blade, comprising:
an airfoil having a leading edge and a trailing edge and which extends from a root end to a tip end, the airfoil having a cavity extending at least a portion of a length of the airfoil between the root and tip ends;
a trailing edge (TE) device disposed within the rotor blade substantially at the trailing edge and configured to operate with a differential pressure, the TE device including a first port and a second port; and
a closeout structure disposed in the cavity, comprising:
a first fluid channel for supplying a first pressure to the first port of the TE device;
a second fluid channel for supplying a second pressure to the second port of the TE device, the second pressure being other than the first pressure to create the differential pressure; and
a trough disposed which forms a seal between the first channel and the second fluid channel, wherein the closeout structure forms a double-W shape.

8. The blade of claim 7, wherein the closeout structure is defined by a first W-shaped member and a second W-shaped member nested at least partially within the first W-shape member to form the double W-shape, wherein the second W-shaped member has a shallower second member trough than a first member trough of the first W-shaped member.

9. The blade of claim 7, wherein the first and second W-shaped members are adhered together.

10. The structure of claim 7, wherein the first W-shaped member includes at least one hole in the first and second fluid channels for ports to fluidly communicate the first and second fluid channels and the ports.

11. The blade of claim 7, further comprising a valve which selectively opens and closes the first and/or second ports to selectively activate the TE device.

12. The blade of claim 7, wherein the first channel is sealed at a tip end of the blade and the second fluid channel is sealed at a root end of the blade.

13. A rotorcraft, comprising:
a fuselage;
a rotor hub rotatably disposed on the fuselage; and
a plurality of rotor blades connected to the rotor hub, each blade including:
a trailing edge (TE) device disposed within the rotor blade substantially at the trailing edge and configured to operate with a differential pressure, the TE device including a first port and a second port; and
a closeout structure disposed in the cavity, comprising:
a first fluid channel for supplying a first pressure to the first port of the TE device;
a second fluid channel for supplying a second pressure to the second port of the TE device, the second pressure being other than the first pressure to create the differential pressure; and
a trough disposed which forms a seal between the first channel and the second fluid channel, wherein the closeout structure forms a double-W shape.

14. The rotorcraft of claim 13, further comprising a controller which controls the TE by selectively applying differential pressure via the first fluid channel and the second fluid channel.

15. The rotorcraft of claim 13, further comprising a valve which selectively opens and closes the first and/or second ports to selectively activate the TE device.
